(19) United States
(12) Patent Application Publication
(10) Pub. No.: US 2025/0018876 A1
(43) Pub. Date: Jan. 16, 2025

(54) STEERING WHEEL CLIPBOARD SYSTEMS FOR VEHICLES

(71) Applicant: David T. Cooper, Clinton Township, MI (US)

(72) Inventor: David T. Cooper, Clinton Township, MI (US)

(21) Appl. No.: 18/772,005

(22) Filed: Jul. 12, 2024

Related U.S. Application Data
(60) Provisional application No. 63/526,194, filed on Jul. 12, 2023.

(51) Int. Cl. B60R 11/00; B43L 1/00

(52) U.S. Cl. CPC B60R 11/00; B43L 1/00; B60R 2011/001; B60R 2011/0059

(57) ABSTRACT

Steering wheel mountable clipboard systems for vehicles. The clipboard systems are substantially circular in design and of two semicircular halves that are joined by a hinge mechanism at the straight side diameters for folding and opened mounting. The clipboard systems include front surface capture and attachment mechanisms and a bottom edge shelf on which can be set items, and an accessory board for further enhancement features and capabilities. The clipboard systems comprise one or more backside straps for engaging the steering wheel and securing the clipboard thereon. The circular clipboard system may also accommodate a mounting board for additional item and device attachment and usage.

### SUMMARY

The following presents a simplified summary in order to provide a basic understanding of some novel embodiments described herein. This summary is not an extensive overview, and it is not intended to identify key/critical elements or to delineate the scope thereof. Its sole purpose is to present some concepts in a simplified form as a prelude to the more detailed description that is presented later.

Disclosed are steering wheel mountable clipboard systems for vehicles. The clipboard systems are predominantly circular in design and of two semicircular halves (the top half is semicircular, and the bottom half is predominantly semicircular in that this half further includes with a flat-edged portion with an outwardly-extending lip, which services as a flat tray on which items can be supported). The halves are joined along the longest straight-side (the diameters) by a hinge mechanism for folding and opened mounting. Each rotatable part of the hinge mechanism attaches to the backside of a corresponding semicircular half.

The clipboard systems can include front surface capture and attachment mechanisms and a bottom edge shelf (also referred to above as the flat-edged portion with an outwardly-extending lip) on which can be set items, and an accessory board for further enhancement features and capabilities.

Description of a suitable accessory board can be found in U.S. Pat. No. 11,247,597, the entirety of which is incorporated by reference herein. The clipboard comprises one or more backside straps for engaging the steering wheel and securing the clipboard thereon. The circular clipboard system may also accommodate a mounting board 602 (also referred to as an auxiliary board) in FIG. 6, for additional item and device attachment and usage. Description of a suitable mounting board is described in detail in U.S. Pat. Nos. 9,827,807, and 10,864,763, as relates to the auxiliary board and all variations and enhancements thereof, the entireties of each are incorporated by referenced herein. The clipboard systems are capable of installation (e.g., temporary, removable, etc.) in a vehicle, such as associated with the vehicle steering system.

Put another way, there is claimed and disclosed a clipboard system for mounting on a vehicle steering wheel, the system comprising: a semicircular upper panel having an upper straight-edged long side and a semicircular lower panel having a lower straight-edged long side; a hinge mechanism which connects the upper straight-edged long side of the upper panel to the lower straight-edged long side of the lower panel; a lower straight-edged short side of the lower panel constructed into curvature of the lower panel, the lower straight-edged short side parallel with the lower straight-edged long side and the hinge mechanism, the lower straight-edged short side defines a lip on the lower panel and which an item can be placed and supported; and a through-hole in the upper panel to enable at least one of mounting the clipboard system to the steering wheel or suspension of the clipboard system away from the steering wheel.

The upper straight-edged long side and lower straight-edged long side individually can define a diameter of the clipboard system. The hinge mechanism comprises multiple parts, wherein one part is mounted on a back surface of the upper panel along the upper straight-edged long side and another part is mounted on a back surface of the lower panel along the lower straight-edged long side.

The clipboard system can further comprise at least one of a first mounting strap on a back surface of the upper panel or a second mounting strap on a back surface of the lower panel, for securing the clipboard system to the steering wheel. The clipboard system can further comprise a clamping apparatus affixed to a front surface of the upper panel for securing items to the clipboard system.

The clipboard system can further comprise a clipping apparatus affixed to a front surface of the lower panel for securing items to the clipboard system. The clipboard system can further comprise attachment mechanisms located proximate the lip, the attachment mechanism enables surface attachment of an item to the lower front surface of the lower panel. The attachment mechanisms enable surface attachment of an item to the clipboard system via at least one of a magnetic contact mechanism, hook-and-loop contact mechanism, or sticky tape contact mechanism. Moreover, the lip of the lower panel, can extend perpendicular to the lower surface of the lower panel, which lip has an underside on which a clip can be retained to hold a writing instrument.

In yet another embodiment described and claimed, a clipboard system for mounting on a vehicle steering wheel, the system comprising: a semicircular upper panel having an upper straight-edged long side and a semicircular lower panel having a lower straight-edged long side; a hinge mechanism which connects the upper straight-edged long side of the upper panel to the lower straight-edged long side of the lower panel; a lower straight-edged short side of the lower panel constructed into curvature of the lower panel, the lower straight-edged short side parallel with the lower straight-edged long side and the hinge mechanism, the lower straight-edged short side defines a lip on the lower panel and which an item can be placed and supported; at least one of a first mounting strap on a back surface of the upper panel or a second mounting strap on a back surface of the lower panel, for securing the clipboard system to the steering wheel; a clamping apparatus affixed to a front surface of the upper panel for securing items to the clipboard system; and, a through-hole in the upper panel to enable at least one of mounting the clipboard system to the steering wheel or suspension of the clipboard system away from the steering wheel.

The clipboard system can further comprise a clipping apparatus affixed to a front surface of the lower panel for securing items to the clipboard system. The hinge mechanism comprises multiple parts, wherein one part is mounted on a back surface of the upper panel along the upper straight-edged long side and another part is mounted on a back surface of the lower panel along the lower straight-edged long side. The lip of the lower panel, extends perpendicular to the lower surface of the lower panel, which lip has an underside on which a clip can be retained to hold a writing instrument.

The clipboard system can further comprise attachment mechanisms located proximate the lip, the attachment mechanism enables surface attachment of an item to the lower front surface of the lower panel. The attachment mechanisms enable surface attachment of an item to the clipboard system via at least one of a magnetic contact mechanism, hook-and-loop contact mechanism, or sticky tape contact mechanism.

In still another embodiment, a clipboard system for mounting on a vehicle steering wheel is described, the system comprising: a semicircular upper panel having an upper straight-edged long side and a semicircular lower panel having a lower straight-edged long side; a hinge mechanism which connects the upper straight-edged long side of the upper panel to the lower straight-edged long side of the lower panel; a lower straight-edged short side of the lower panel constructed into curvature of the lower panel, the lower straight-edged short side parallel with the lower straight-edged long side and the hinge mechanism, the lower straight-edged short side defines a lip on the lower panel and which an item can be placed and supported; attachment mechanisms located proximate the lip, the attachment mechanisms enable surface attachment of an item to the lower front surface of the lower panel; at least one of a first mounting strap on a back surface of the upper panel or a second mounting strap on a back surface of the lower panel, for securing the clipboard system to the steering wheel; a clamping apparatus affixed to a front surface of the upper panel for securing items to the clipboard system; and a through-hole in the upper panel to enable at least one of mounting the clipboard system to the steering wheel or suspension of the clipboard system away from the steering wheel.

The clipboard system can further comprise a clipping apparatus affixed to a front surface of the lower panel for securing items to the clipboard system. The clipboard system can further comprise a mounting board mounted on the front surfaces of the clipboard system via capture by the clamping apparatus and an attachment mechanism, the mounting board enables an expansive surface on which items can be attached.

The lip of the lower panel, extends perpendicular to the lower surface of the lower panel, which lip has an underside on which a clip can be retained to hold a writing instrument. The attachment mechanisms enable surface attachment of an item to the clipboard system via at least one of a magnetic contact mechanism, hook-and-loop contact mechanism, or sticky tape contact mechanism.

To the accomplishment of the foregoing and related ends, certain illustrative aspects are described herein in connection with the following description and the annexed drawings. These aspects are indicative of the various ways in which the principles disclosed herein can be practiced and all aspects and equivalents thereof are intended to be within the scope of the claimed subject matter. Other advantages and novel features will become apparent from the following detailed description when considered in conjunction with the drawings.

### BRIEF DESCRIPTION OF THE DRAWINGS

FIG. 1 illustrates a vehicle-mountable clipboard system in accordance with the disclosed architecture.

FIG. 2 illustrates an alternative vehicle-mountable clipboard system in accordance with the disclosed architecture.

FIG. 3 illustrates a circular clipboard system in accordance with the disclosed architecture and which can accommodate a mounting board which expands the utility of the clipboard system.

FIG. 4 illustrates an alternative vehicle-mountable clipboard system in accordance with the disclosed architecture.

FIG. 5 illustrates an alternative vehicle-mountable clipboard system in accordance with the disclosed architecture.

FIG. 6 illustrates a vehicle steering wheel mountable clipboard system configured to receive a compatible mounting board which expands on the capabilities of the clipboard system.

FIG. 7 illustrates a view of the mounting board in accordance with the disclosed architecture.

### DETAILED DESCRIPTION

Reference is now made to the drawings, wherein like reference numerals are used to refer to like elements throughout. In the following description, for purposes of explanation, numerous specific details are set forth in order to provide a thorough understanding thereof. It may be evident, however, that the novel embodiments can be practiced without these specific details. The intention is to cover all modifications, equivalents, and alternatives falling within the spirit and scope of the claimed subject matter.

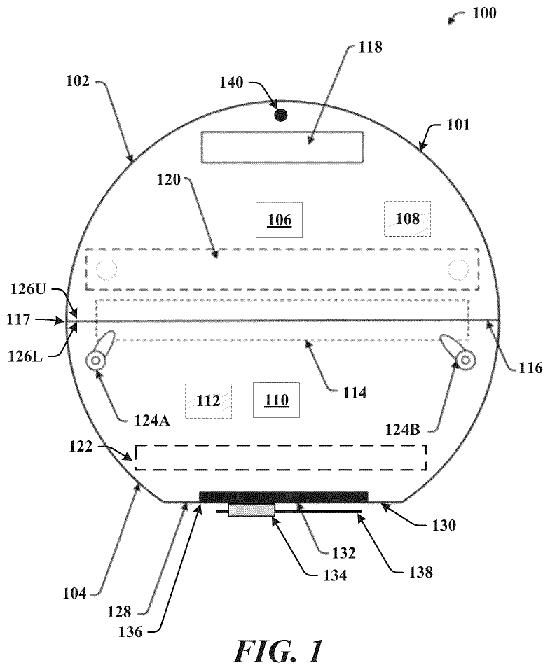

FIG. 1 illustrates a vehicle-mountable clipboard system 100 in accordance with the disclosed architecture. The clipboard system 100 can comprise several features which facilitate usage via a vehicle steering system (e.g., a steering wheel mounted to a center steering column (not shown) which facilitates steering of the vehicle by the user as the vehicle is driven), and which vehicle steering system can be employed in substantially all vehicles and vehicles types having steering systems which enable temporary, but secure, attachment to such steering systems. The vehicle steering system is a base onto which the clipboard system 100 can be attached and supported for use while the vehicle is parked.

In one implementation, the features of the clipboard system 100 comprise a clipboard 101 of circular design comprising two semicircular panels; an upper semicircular panel 102 and a lower (substantially) semicircular panel 104. The panels (102 and 104) provide the base structure onto which numerous system features and functionality are manufactured.

The upper panel 102 is depicted as having an upper front surface 106 and an upper back surface 108 (the upper back surface label 108 depicted as a dashed-line block with a grayed fill). Similarly, the lower panel 104 is depicted as having a lower front surface 110 and a lower back surface 112 (the lower back surface label 112 depicted as a dashed-line block with a grayed fill).

Panels (102 and 104) can be interconnected by a hinge mechanism 114 (e.g., metal, plastic, nylon, etc.) that facilitates folding the two panels (102 and 104) together along a mechanically hinged axis 116 (also the diameter 117 of the circular clipboard system 100) of the hinge mechanism 114.

In one embodiment, the hinge mechanism 114 can be mounted on the back surfaces (also referred to as “backsides”) of the clipboard 101 such that an upper part of the (two-part) hinge mechanism 114 affixes to the back surface 108 of the upper panel 102, but proximate the straight long side 126U (at the diameter 117) of the upper panel 102, and a lower part of the two-part hinge mechanism affixes to the lower back surface 112 of the lower panel 104, but proximate the straight long side 126L (at the diameter 117) of the lower panel 104.

In an alternative embodiment, the hinge mechanism 114 can be mounted on the front surfaces (also referred to as “frontside”) of the clipboard 101 such that an upper part of the (two-part) hinge mechanism 114 affixes to the front surface 106 of the upper panel 102, but proximate the straight long side 126U (at the diameter 117) of the upper panel 102, and the lower part of the two-part hinge mechanism 114 affixes to the lower front surface 110 of the lower panel 104, but proximate the straight long side 126L (at the diameter 117) of the lower panel 104.

The hinge mechanism 114 enables detaching, and folding of the clipboard 101 backward (toward the steering wheel, relative as if the user was seated in the vehicle) such that the upper and lower back surfaces 108 and 112) and/or back surface objects/features face and/or contact each other, or folding of the clipboard 101 forward (away from the steering wheel and toward the user, relative as if the user was seated in the vehicle) such that the upper and lower front surfaces (106 and 110) and/or front surface objects/features face and/or contact each other.

Once folded into a single, final semicircular formfactor, the system 100 can be carried, stored, and/or inserted into a carrying case. Such a carrying case can be found in U.S. Pat. No. 11,247,597, the entirety of which is incorporated by reference herein.

More specifically, and according to other embodiments, the hinge mechanism 114 is depicted as bordered by a dashed line, which indicates the hinge mechanism 114 can be mounted to the back surfaces (108 and 112) of the respective panels (102 and 104). In this hinged design, the two panels (102 and 104) can be restricted to folding onto each other in only one direction (a one-way swivel hinge), such as away from the driver seat where a driver would normally be situated during use. In other words, the folding operation rotation is restricted such that the back surfaces (108 and 112) of the panels (102 and 104) fold onto or towards each other (i.e., in only one direction).

Alternatively, the hinge mechanism 114 can be a two-way swivel hinge designed and mounted so that folding of the panels (102 and 104) can occur in both directions. That is, the top panel 102 and bottom panel 104 each fold away from the driver seat such that the back surfaces (108 and 112) are facing each other in the final folding formfactor); and in a second folding operation, the front surfaces (106 and 110) of the panels (102 and 104) both fold towards each other (towards the driver seat) resulting in a final formfactor where the front surfaces (106 and 110) are facing each other in the final folding formfactor.

The upper panel 102 comprises a spring-loaded clamping apparatus 118 mounted on the front surface 106 and proximate the top curved edge of the semicircular upper panel 102, which enables the capture of items for use with the clipboard 100. The clamping apparatus 118 can be affixed (e.g., permanently, temporarily, removably, etc.) on the front surface 106 of the upper panel 102 to enable capture of documents, papers, straps, pens, accessories, for example, such as an auxiliary board (not yet depicted) for temporarily capturing other compatible items. Items such as portable electronic devices (e.g., cell phone, tablet, etc.), personal items (e.g., mirrors, combs, etc.), and/or anything suitable for fitting into and/or onto the clamping apparatus 118 can be captured therein for holding, interacting, and re-positioning purposes.

As depicted, the back surface 108 of the upper panel 102 includes a mounting strap 120 (dashed line block for the back surface mounting, or toward the steering wheel) which enables the positioning and hanging of the circular clipboard system 100 on the vehicle steering wheel. The strap 120 can be elastic and/or rigid in design, and, for example, having an elasticity sufficient to firmly hold the clipboard 100 to the steering wheel (e.g., system), when the clipboard system is loaded with other objects and materials.

Other mechanisms suitable for firmly holding the clipboard 100 to the steering wheel can be utilized, such as metal bands, hooks, etc. Thus, alternatively, or in combination therewith, the clipboard system 100 can employ a second strapping mechanism 122 mounted to the back surface 112 of the lower panel 104, and positioned near the bottom of the back surface 112 of the lower panel 104, and for which can be strapped over the lower portion of a circular steering wheel of a vehicle. This provides two strapping mechanisms (120 and 122) providing opposing forces to more securely mount the clipboard system 100 to the steering wheel and maintain the position of the clipboard system 100 relative to the center of the steering wheel.

The lower panel 104 can further include two clipping apparatuses (124A and 124B) located on the lower front surface 110 to assist in retaining documents, papers, etc., to the front side (the combination of front surfaces (upper front surface 106 and lower front surface 110)) of the clipboard system 100 in a more flattened manner, for example.

The clipping apparatuses (124A and 124B) include two pliable (flexible) clips (e.g., made of flexible material such as nylon, plastic, and/or metal) affixed to the lower panel 104: the first clipping apparatus 124A disposed diametrically opposite to the second clipping apparatus clip 124B and proximately located near the circle diameter 117 and/or hinge axis 116, where the diameters of the upper panel 102 and lower panel 104 are equal and proximate.

More specifically, at the center of the circular clipboard system 100 is its diameter 117. The diameter 117 defines the line of separation between straight long side 126U of the upper panel 102 to the straight long side 126L of the lower panel 104, thereby separating the circular clipboard system 100 into the upper panel 102 and the lower panel 104.

The hinge mechanism 114 can be designed to span nearly the entire length of the diameter 117, a partial length of the diameter 117, or multiple hinges affixed along the diameter 117 at multiple respective points of the back surfaces (108 and 112) and/or the front surfaces (106 and 110). It is to be appreciated that, as indicated above, the hinge mechanism 114 can alternatively be mounted along the diameter 117 on the front surfaces (106 and 110) as a single-swivel or double-swivel hinge system.

The lower panel 104 is depicted as further comprising a lower straight edge 128 that is parallel in the same plane as the straight long side 126L, yet a geometric chord of the semicircular curved portion of the lower panel 104, of lesser length than the diameter 117 and straight long side 126L, in the same plane as the lower panel 104, parallel to the diameter 117, and parallel to the straight long side 126L.

Hence, the presence of this lower straight edge 128 of the lower panel 104 and the straight long side 126L of lower panel 104, represent the “substantially” circular and semicircular designation of the system 100.

The lower straight edge 128 can also define a lip (or shelf) 130 along the entire length of the lower straight edge 128 (e.g., six inches), or along a portion (e.g., four inches) of the lower straight edge 128, but of sufficient length and sturdiness to support materials and devices that may be placed on the lip 130 and against the clipboard system 100 when in use. Although not clearly illustrated in FIG. 1, the lip 130 can extend perpendicular to and outwardly from (toward the driver seat or driver) the lower front surface 110 of the lower panel 104 to about a half inch, one inch, or of a sufficient distance, etc. to support expected materials and devices which might be placed there by a user. Shown is an object 132 (e.g., writing instrument, stylus pen, control module, etc.) placed on top of the lip 130 while being in use.

The lip 130 can also be designed to further include a clip 134 (e.g., flexible nylon capture clip) affixed to the underside 136 of the lip 130 to retain a writing instrument 138, for example, or other suitable and compatible object (e.g., a charging cable, data connector, ear plugs for audio signals, etc.).

Optionally, the clipboard system 100 of FIG. 1 can also include a through-hole 140 near the top of the upper panel 102 which can serve as a way to simply hang the entire clipboard system 100 (empty of items and/or devices or loaded with items and/or devices) on a wall peg or hanger for easy access when desired and for easy stowing when not needed. The hole 140 can also accommodate support items which enable securing the system 100 to the steering wheel, such as a threaded hook or captured latch that when engaging the hole 140 enables fixing the system 100 to the steering wheel at that location.

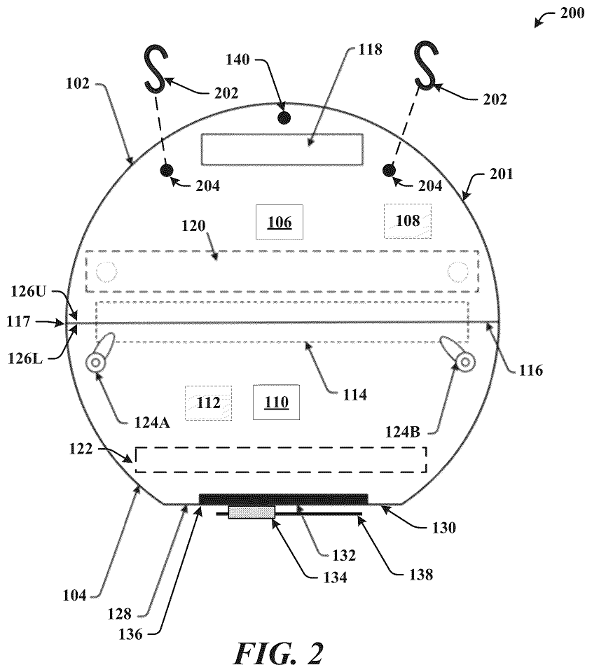

FIG. 2 illustrates an alternative vehicle-mountable clipboard system 200 in accordance with the disclosed architecture. In one implementation, the features of the clipboard system 200 comprise a clipboard 201 of generally circular design comprising two generally semicircular panels; the upper panel 102 and lower panel 104. The panels (102 and 104) provide the base structure onto which numerous system features are manufactured.

In this embodiment, separately, or in addition to the strap 120 or straps (120 and 122) employed in the system 100 of FIG. 1, the system 200 can further include two pliable hooks 202 (e.g., nylon bucket J-hooks) in the left and right sides of the upper panel 106 which engage pre-fabricated holes 204 in the upper panel 106 can be used to hook around the steering wheel on either side of the upper left and upper right, thereby providing separate or additional support of the entire clipboard system 200 and added materials and equipment (e.g., personal devices such a cell phones, portable computing devices, power charging devices, etc.). The bucket hooks 202 can comprise a smaller curved end for hole 204 capture, and a larger curved end which can be sized to apply secure slip-on compression capture to the upper grips of the steering wheel.

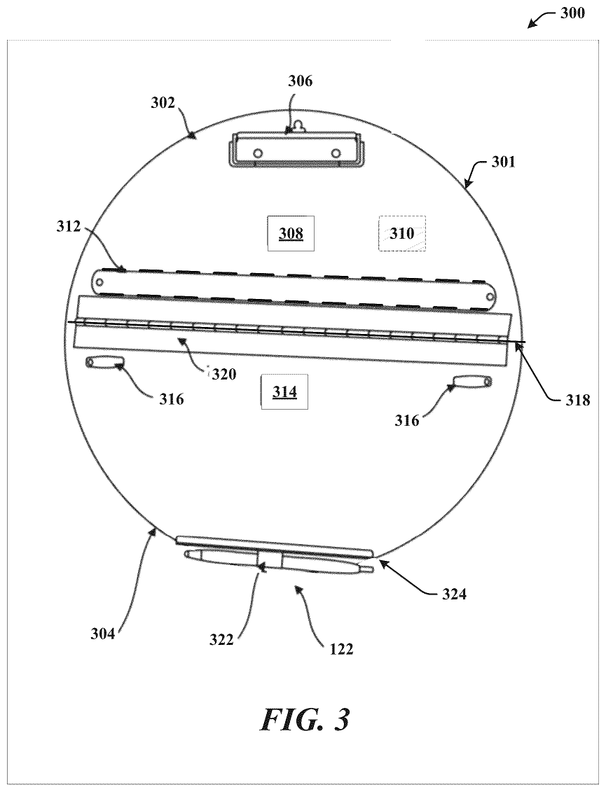

FIG. 3 illustrates a circular clipboard system 300 (similar in some respects to clipboard systems 100 and 200) in accordance with the disclosed architecture and which can accommodate a mounting board (described herein) which expands the utility of the system 300 (as well as systems 100 and 200, for example).

In one implementation, the features of the clipboard system 300 comprise a clipboard 301 of circular design which includes two semicircular panels; an upper panel 302 and a lower panel 304. The panels (302 and 304) provide the base structure onto which numerous system features and functionality are manufactured. The upper panel 302 comprises a spring-loaded clamping apparatus 306 affixed on a front side 308 that enables the capture of items for use with the clipboard system 300. For example, documents, papers, straps, pens, etc., or anything suitable for fitting into the clamping apparatus 306 can be captured therein for holding and re-positioning purposes.

A back side 310 of the upper panel 302 includes a strap 312 (designated as a dashed-line item near the diameter of the clipboard 301) which enables the positioning of the circular clipboard 300 on a vehicle steering wheel. The strap 312 (similar to strap 120) can be elastic, having an elasticity sufficient to firmly hold the clipboard system 300 to the steering wheel of a vehicle.

Other mechanisms suitable for firmly holding the clipboard system 300 to the steering wheel can be utilized. For example, two pliable hooks (e.g., bucket) can be implemented on the back side 310 of the upper panel 302 that when engaging the steering wheel, will support the clipboard system 300 and firmly hold the clipboard system 300 to the upper curvature of the vehicle steering wheel.

The lower panel 304 comprises a front side 314 on which one or more rotatable clipping apparatus 316 are located to assist in retaining documents, papers, etc., to the front side (made up of the front sides 308 and 314) of the clipboard system 300. The clipping apparatuses 316 include two (pliable) clips (made of, e.g., flexible nylon) affixed to the lower panel 304 and one clipping apparatus 316 is disposed diametrically opposite to the other clipping apparatus 316 and proximately located near the diameter 318 of the circular clipboard system 300, where the upper panel 302 and lower panel 304 meet via a mechanical hinge 320.

More specifically, at the center of the circular clipboard system 300 is its diameter 318. The diameter 318 defines the line of separation between longest straight sides of the upper panel 302 and the lower panel 304, thereby separating the circular clipboard system 300 into the two semi-circular panels—the upper panel 302 and the lower panel 304.

The upper panel 302 and lower panel 304 are connected along the diameter 318 by way of the hinge system 320 (e.g., plastic, metal, etc.). The hinge system 320 can be designed to span the entire length of the longest straight sides of the panels (302 and 304) at the diameter 318 or portions of the longest straight sides of the panels (302 and 304) at the diameter 318. Using the hinge system 320, the two panels (302 and 304) can then be folded onto each other resulting in a final folded clipboard configuration about the size of one semi-circular panel (302 or 304).

At the bottom of the lower panel 304 is located a pen/pencil holder clip 322 which retains a pen or pencil, or other device(s) the user chooses to stow there. Additionally, at the bottom of the lower panel 304 can be implemented a flat and horizontally oriented “lip” or shelf 324, similar in general design as the lip 130 (or shelf) of the clipboard systems (100 and 200) and for resting items near the bottom edge or location of the circular clipboard 301. The holder clip 322 can be located under the lip 324 to protect against liquids that might otherwise reach a pen or other object captured therein, etc., that might be spilled without the lip 130.

As illustrated, the hinge system 320 can be mounted on the front sides (308 and 314) of the upper and lower panels (302 and 304), and still facilitate folding of the clipboard system 300 into a more compact formfactor to fit into a compatible case for storage, travel, and other purposes.

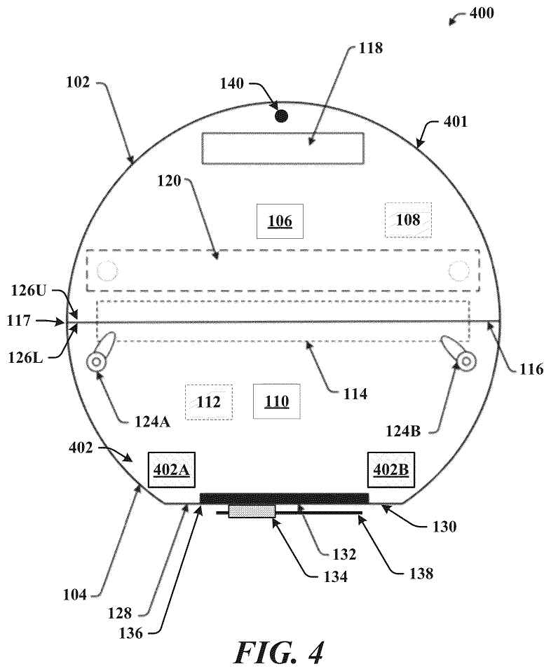

FIG. 4 illustrates an alternative vehicle-mountable clipboard system 400 in accordance with the disclosed architecture. The features (components) of the clipboard system 400 comprise a clipboard 401 of circular design comprising two semicircular panels; the upper panel 102 and lower panel 104. The panels (102 and 104) provide the base structure onto which numerous system features are manufactured.

Clipboard system 400 is similar in many features as to clipboard systems (100 and 200), with the exception of one or more additional attachment mechanisms 402, such as mechanisms 402A and/or 402B on the front surface 110 of the lower panel 104, on opposite sides proximate to and above the lip 130. The attachment mechanisms 402 can be located near the bottom of the lower panel 104 to facilitate the capture of products (e.g., papers, paper pad backboards, clipboards, files, contact boards, pictures, devices, etc.) that can be used in conjunction with the clipboard system 400.

For example, the attachment mechanisms 402A and/or 402B can be parts of a hook-and-loop technology (e.g., VELCRO) affixed to the lower panel 104, which operates according compatible mating principles of a hook mechanism (e.g., a patch) connecting to a loop patch, and a loop patch connecting to a hook patch. Thus, an additional device, apparatus, document, pad, board, etc., or the like that includes a mating loop patch will be removably secured when attaching to the mating hook patch. Similarly, the additional device, apparatus, document, pad, board, etc., or the like, that includes a mating hook patch will be removably secured when attaching to the mating loop patch.

Alternatively, or in combination therewith, the one or more attachment mechanisms 402A and/or 402B can be magnetic technologies that couple to metal objects on or in proximity to the magnetic attachment mechanisms. The attachment strip(s) can be dedicated space(s) on the clipboard surface(s) intended for temporary/permanent attachments of user-desired items (e.g., mirror, documents, cards, objects (e.g., metal, plastic, etc.). Still further, sticky tape technology (permanent and/or removable) can be utilized such that a tape piece (e.g., strip) can be readily applied to the surface(s), and then left on the surface or removed from the surface when no longer wanted or needed.

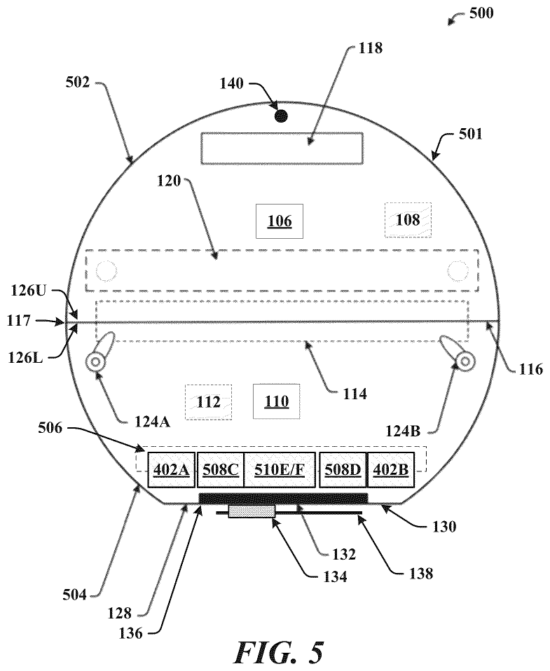

FIG. 5 illustrates an alternative vehicle-mountable clipboard system 500 in accordance with the disclosed architecture. In one implementation, the features of the clipboard system 500 comprise a clipboard 501 of generally circular design which includes two semicircular panels; an upper panel 502 and a lower panel 504. The panels (502 and 504) provide the base structure onto which numerous system features and functionality are manufactured.

Clipboard system 500 is similar in many features as to clipboard systems (100, 200, 300, and 400), with the exception of an attachment strip 506 (or group) of different types of attachment mechanisms. The strip 506 can be located on the lower front surface 110 near the bottom of the lower panel 504, but above the lip 130, to facilitate the capture of products and devices (e.g., papers, paper pad backboards, clipboards, files, contact boards, pictures, devices, etc.) that can be used in conjunction with the clipboard system 500.

In still another alternative attachment mechanism subsystem, the attachment strip 506 employs a variety of mixed attachment technologies designed on or into the lower panel 504. The variety of mixed attachment technologies can comprise hook-and-loop technology (402A and 402B), magnetic technology (508C and 508D), and/or a sticky technology (510E and 510F) (e.g., manufactured by TESA) such as double-sided sticky tapes or plugs that can be applied to a surface and then removed at a later time without effort and residual sticky material remaining on the surfaces, etc., all to accommodate several different needs in securing devices and/or documents to the clipboard system 500 to at least the front surface 110 of the lower panel 504.

It is within contemplation of the disclosed architecture that one or more of the varieties of attachment technologies as part of the strip 506 can be sited at different locations on the front surfaces (106 and/or 110) and/or back surfaces (108 and/or 112) of the lower and upper panels (502 and/or 404). As shown herein, these attachment technologies can facilitate the introduction of a mounting board which expands the functionality of the clipboard systems described herein.

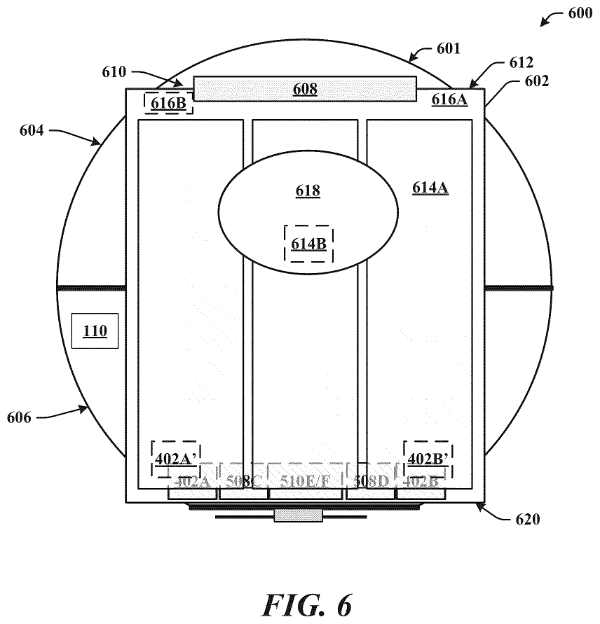

FIG. 6 illustrates a vehicle steering wheel mountable clipboard system 600 configured to receive a compatible mounting board 602 which expands on the capabilities of the clipboard system 600. As with the other clipboard systems (100, 200, 300, 400, and 500) described herein, the clipboard system 600 comprises a clipboard 601 of circular design which includes two semicircular panels; an upper panel 604 and a lower panel 606. The panels (604 and 606) provide the base structure onto which numerous system features and functionality are manufactured. As with the other clipboard systems (100, 200, 300, 400, and 500), the panels (604 and 606) are joined together along the respective diameters (or straight sides) by a hinge mechanism that extends all or part of the length of the diameters.

The mounting board 602 can itself be captured to the underlying clipboard 601 via a clamping apparatus 608 (similar to clamping apparatus 118 shown in FIG. 1, FIG. 2, FIG. 4, and FIG. 5 and/or clamping apparatus 306 in FIG. 3). A capture location 610 on the mounting board 602 can be along the top edge 612 of the board 602 which enables securing of the mounting board 602 to the clipboard 601 within the provided clamping apparatus 608.

The mounting board 602 can have a topside surface 616A and a backside surface 616B (dashed line block represents a label of the backside surface). The mounting board 602 can provide at least one frontside (or topside) attachment technology 614A (e.g., hook-and-loop, etc.) on the topside surface 616A and onto which objects having a compatible attachment technology (e.g., hook-and-loop) can be placed, attached, and secured (and subsequently removed) for user purposes.

For example, a mirror 618 having a backside attachment technology 614B (the dashed line block 614B represents a backside or back surface of the mirror 618) which is compatible with the topside attachment technology 614A, can be temporarily secured on the topside surface 616A of the mounting board 602. The mounting board 602 enables an increased or more expansive surface on which items can be attached.

Other items, such as documents, hardware, devices, files, pouches, etc., which have an attachment technology compatible with the attachment technology 614A, can benefit from secure attachment to the topside surface 616A of the mounting board 602.

In order to provide a more secure implementation of the mounting board 602 to the clipboard 601, at least as relates to the lower part of the board 602, the backside surface 616B of the mounting board 602 can further comprise one or more backside attachment points (402A′ and 402B′) located near the lower edge 620 of the board 602, and spaced apart such that one backside attachment point 402A′ is located near the lower corner left corner of the board 602, and the other backside attachment point 402B′ is located near the lower corner left corner of the board 602.

The board backside attachments points (402A′ and 402B′) can be surfaced or be embedded with any type of attachment technology (e.g., hook-and-loop) to facilitate a more secure attachment of the lower area of the board 602 to the clipboard 601. Accordingly, for structural compatibility, the lower panel 606 of the clipboard 601 can employ matching attachment points (402A and 402B) and attachment technology located in alignment with the backside attachments points (402A′ and 402B′). This provides a more secure use of the mounting board while on the clipboard 601.

As described in conjunction with clipboard system 500 of FIG. 5, the attachment strip 506 technique employs a variety of mixed attachment technologies designed on or into the lower panel 504. This can be applied to utilization of the mounting board 602 with the clipboard system 600, as well as for other accessories that work with compatible attachment technologies to the clipboard system and/or the mounting board 602.

When used with the mounting board 602, the strip 506 of different attachment technologies offer several ways of attachment security for the board 602 and possibly other items and devices that include compatible attachment technology. As described herein, the attachment technologies can comprise one or more of the following (as well as other technologies not mention here, but commonly employed in such ways): hook-and-loop technology (402A and 402B), magnetic technology (508C and 508D), and/or a sticky technology (510E and 510F) (e.g., manufactured by TESA) such as double-sided sticky tapes or plugs that can be applied to a surface and then removed at a later time without effort and residual sticky material remaining on the surfaces, etc., all to accommodate several different needs in securing devices and/or documents to the clipboard system 600 to at least the front surface 110 of the lower panel 606.

As further illustrated, by semi-transparency through the lower part of the mounting board 602, the other attachment technologies 508C, 508D, 510E, and 510F can be seen attached to the lower part of the lower panel 606. However, it is to be understood that the clipboard system 600 can include multiple attachment technologies positioned at various points on the clipboard surface, as deem likely locations for objects, devices, papers, etc.

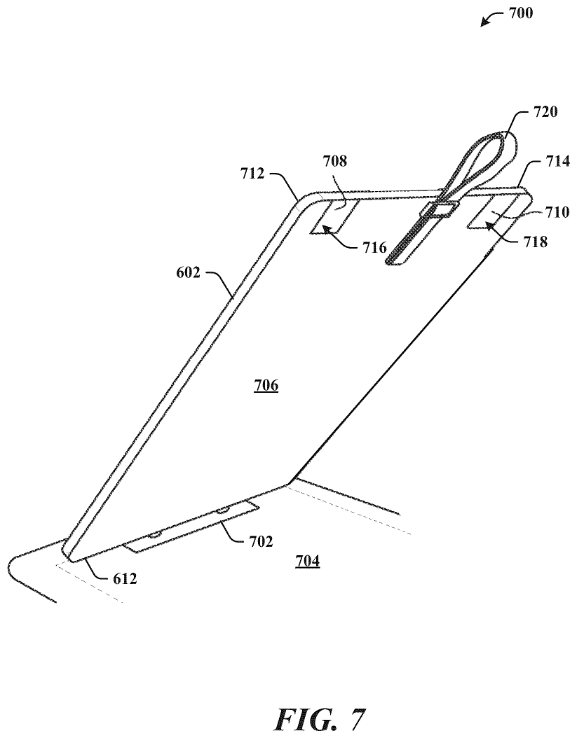

FIG. 7 illustrates an isometric view 700 of the mounting (auxiliary) board 602 in accordance with the disclosed architecture. The view 700 depicts the board 602 in an elevated pose at one end with the top edge 612 captured mode by a clamping apparatus of 702 of a clipboard 704. The underside or backside 706 of the mounting board 602 is exposed to depict two attachment points (708 and 710) near the respective lower corners (712 and 714) for the placement of two attachment mechanism (716 and 718) technologies (e.g., VELCRO, magnetics, sticky products, etc.). Once lowered down and into position against the upper face of the clipboard 704, the attachment mechanisms (716 and 718) will securely engage compatible attachment points (not shown) on the upper face of the clipboard 704. Although appearing to be a standard rectangular clipboard, the clipboard 704 can be replaced with any of the described circular clipboards (e.g., 101, 201, 301, 401, 501, or 601). The mounting board 602 also includes a finger strap 720 for increased ease of handling and placement, for example, on clipboard systems.

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A clipboard system for mounting on a vehicle steering wheel, the system comprising:
a semicircular upper panel having an upper straight-edged long side and a semicircular lower panel having a lower straight-edged long side;
a hinge mechanism which connects the upper straight-edged long side of the upper panel to the lower straight-edged long side of the lower panel;
a lower straight-edged short side of the lower panel constructed into curvature of the lower panel, the lower straight-edged short side parallel with the lower straight-edged long side and the hinge mechanism, the lower straight-edged short side defines a lip on the lower panel and which an item can be placed and supported; and
a through-hole in the upper panel to enable at least one of mounting the clipboard system to the steering wheel or suspension of the clipboard system away from the steering wheel.

2. The clipboard system of claim 1, wherein the upper straight-edged long side and lower straight-edged long side individually define a diameter of the clipboard system.

3. The clipboard system of claim 1, wherein the hinge mechanism comprises multiple parts, wherein one part is mounted on a back surface of the upper panel along the upper straight-edged long side and another part is mounted on a back surface of the lower panel along the lower straight-edged long side.

4. The clipboard system of claim 1, further comprising at least one of a first mounting strap on a back surface of the upper panel or a second mounting strap on a back surface of the lower panel, for securing the clipboard system to the steering wheel.

5. The clipboard system of claim 1, further comprising a clamping apparatus affixed to a front surface of the upper panel for securing items to the clipboard system.

6. The clipboard system of claim 1, further comprising a clipping apparatus affixed to a front surface of the lower panel for securing items to the clipboard system.

7. The clipboard system of claim 1, wherein the lip of the lower panel, extends perpendicular to the lower surface of the lower panel, which lip has an underside on which a clip can be retained to hold a writing instrument.

8. The clipboard system of claim 1, further comprising attachment mechanisms located proximate the lip, the attachment mechanism enables surface attachment of an item to the lower front surface of the lower panel.

9. The clipboard system of claim 8, wherein the attachment mechanisms enable surface attachment of an item to the clipboard system via at least one of a magnetic contact mechanism, hook-and-loop contact mechanism, or sticky tape contact mechanism.

10. A clipboard system for mounting on a vehicle steering wheel, the system comprising:
a semicircular upper panel having an upper straight-edged long side and a semicircular lower panel having a lower straight-edged long side;
a hinge mechanism which connects the upper straight-edged long side of the upper panel to the lower straight-edged long side of the lower panel;
a lower straight-edged short side of the lower panel constructed into curvature of the lower panel, the lower straight-edged short side parallel with the lower straight-edged long side and the hinge mechanism, the lower straight-edged short side defines a lip on the lower panel and which an item can be placed and supported;
at least one of a first mounting strap on a back surface of the upper panel or a second mounting strap on a back surface of the lower panel, for securing the clipboard system to the steering wheel;
a clamping apparatus affixed to a front surface of the upper panel for securing items to the clipboard system; and
a through-hole in the upper panel to enable at least one of mounting the clipboard system to the steering wheel or suspension of the clipboard system away from the steering wheel.

11. The clipboard system of claim 10, further comprising a clipping apparatus affixed to a front surface of the lower panel for securing items to the clipboard system.

12. The clipboard system of claim 10, wherein the hinge mechanism comprises multiple parts, wherein one part is mounted on a back surface of the upper panel along the upper straight-edged long side and another part is mounted on a back surface of the lower panel along the lower straight-edged long side.

13. The clipboard system of claim 10, wherein the lip of the lower panel, extends perpendicular to the lower surface of the lower panel, which lip has an underside on which a clip can be retained to hold a writing instrument.

14. The clipboard system of claim 10, further comprising attachment mechanisms located proximate the lip, the attachment mechanism enables surface attachment of an item to the lower front surface of the lower panel.

15. The clipboard system of claim 14, wherein the attachment mechanisms enable surface attachment of an item to the clipboard system via at least one of a magnetic contact mechanism, hook-and-loop contact mechanism, or sticky tape contact mechanism.

16. A clipboard system for mounting on a vehicle steering wheel, the system comprising:
a semicircular upper panel having an upper straight-edged long side and a semicircular lower panel having a lower straight-edged long side;
a hinge mechanism which connects the upper straight-edged long side of the upper panel to the lower straight-edged long side of the lower panel;
a lower straight-edged short side of the lower panel constructed into curvature of the lower panel, the lower straight-edged short side parallel with the lower straight-edged long side and the hinge mechanism, the lower straight-edged short side defines a lip on the lower panel and which an item can be placed and supported;
attachment mechanisms located proximate the lip, the attachment mechanisms enable surface attachment of an item to the lower front surface of the lower panel;
at least one of a first mounting strap on a back surface of the upper panel or a second mounting strap on a back surface of the lower panel, for securing the clipboard system to the steering wheel;
a clamping apparatus affixed to a front surface of the upper panel for securing items to the clipboard system; and
a through-hole in the upper panel to enable at least one of mounting the clipboard system to the steering wheel or suspension of the clipboard system away from the steering wheel.

17. The clipboard system of claim 16, further comprising a clipping apparatus affixed to a front surface of the lower panel for securing items to the clipboard system.

18. The clipboard system of claim 16, wherein the lip of the lower panel, extends perpendicular to the lower surface of the lower panel, which lip has an underside on which a clip can be retained to hold a writing instrument.

19. The clipboard system of claim 16, wherein the attachment mechanisms enable surface attachment of an item to the clipboard system via at least one of a magnetic contact mechanism, hook-and-loop contact mechanism, or sticky tape contact mechanism.

20. The clipboard system of claim 16, further comprising a mounting board mounted on the front surfaces of the clipboard system via capture by the clamping apparatus and an attachment mechanism, the mounting board enables an expansive surface on which items can be attached.
